(19) United States
(12) Patent Application Publication
(10) Pub. No.: US 2023/0190406 A1
(43) Pub. Date: Jun. 22, 2023

(54) Stackable Foundation Guide and Method of Using Same

(71) Applicant: DDS Company, Inc., Durham, NC (US)

(72) Inventor: Cornelis J. Janse Van Rensburg, Durham, NC (US)

(73) Assignee: DDS Company, Inc., Durham, NC (US)

(21) Appl. No.: 18/106,563

(22) Filed: Feb. 7, 2023

Related U.S. Application Data
(63) Continuation-in-part of application No. 16/869,698, filed on May 8, 2020.
Application No. 16/869,698 is a continuation-in-part of application No. 16/869,717, filed on May 8, 2020.
Application No. 16/869,717 is a continuation-in-part of application No. 17/469,435, filed on Sep. 8, 2021.
(60) Provisional application No. 63/320,740, filed on Mar. 17, 2022.
(60) Provisional application No. 63/394,991, filed on Aug. 4, 2022.
(60) Provisional application No. 63/403,904, filed on Sep. 6, 2022.
(60) Provisional application No. 62/845,540, filed on May 9, 2019.
(60) Provisional application No. 62/872,829, filed on Jul. 11, 2019.
(60) Provisional application No. 62/912,821, filed on Oct. 9, 2019.
(60) Provisional application No. 62/845,540, filed on May 9, 2019.
(60) Provisional application No. 62/872,829, filed on Jul. 11, 2019.
(60) Provisional application No. 62/912,821, filed on Oct. 9, 2019.
(60) Provisional application No. 63/078,600, filed on Sep. 15, 2020.
(60) Provisional application No. 63/090,907, filed on Oct. 13, 2020.

(51) Int. Cl. A61C 1/08

(52) U.S. Cl. CPC A61C 1/084

(57) ABSTRACT

A stackable surgical foundation guide. The stackable surgical foundation guide may include a body portion having a generally arcuate shape; one or more connector bodies spaced generally about the body portion; one or more fixation ports spaced about the body portion, each of the one or more fixation ports forming a passageway therethrough. The stackable surgical foundation guide may further include at least one stabilization arm affixed to the body portion, the at least one stabilization arm may be configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth. The body portion of the stackable surgical foundation guide may further include a first portion and a second portion that may be coupled together at about a center point thereof in a hingeable manner.

### RELATED APPLICATIONS

This application claims priority to U.S. Provisional Patent App. Nos. 63/320,740, filed Mar. 17, 2022; 63/394,991, filed Aug. 4, 2022; and 63/403,904, filed Sep. 6, 2022, the entire disclosures of which are incorporated herein by reference.

This application is a continuation-in-part of U.S. patent application Ser. No. 16/869,698, filed May 8, 2020, the application of which claims priority to U.S. Provisional Patent App. Nos. 62/845,540, filed May 9, 2019; 62/872,829, filed Jul. 11, 2019; and 62/912,821, filed Oct. 9, 2019, the entire disclosures of which are incorporated herein by reference.

This application is a continuation-in-part of U.S. patent application Ser. No. 16/869,717, filed May 8, 2020, the application of which claims priority to U.S. Provisional Patent App. Nos. 62/845,540, filed May 9, 2019; 62/872,829, filed Jul. 11, 2019; and 62/912,821, filed Oct. 9, 2019, the entire disclosures of which are incorporated herein by reference.

This application is a continuation-in-part of U.S. patent application Ser. No. 17/469,435, filed Sep. 8, 2021, the application of which claims priority to U.S. Provisional Patent App. Nos. 63/078,600, filed Sep. 15, 2020 and 63/090,907, filed Oct. 13, 2020, the entire disclosures of which are incorporated herein by reference.

### TECHNICAL FIELD

The subject matter of the present invention relates generally to surgical guides used in the dental industry and more particularly to a stackable surgical foundation guide.

### BACKGROUND

Currently, intraoral guided surgery procedures, such as, but not limited to, intraoral dental implant surgical procedures, utilize stackable dental surgical guides and methods. However, certain drawbacks may exist when using these surgical guides and methods. For example, with many of the current guides it can be difficult to get the guide properly aligned and seated in a patient's mouth and keep it stable during a surgical procedure. Accordingly, new approaches are needed with respect to properly seating and stabilizing of surgical guides in performing intraoral guided surgery procedures.

### SUMMARY

In one embodiment, a stackable foundation guide is provided. The stackable foundation guide may include a body portion having a generally arcuate shape; one or more connector bodies spaced generally about the body portion; one or more fixation ports spaced about the body portion, each of the one or more fixation ports forming a passageway therethrough; and at least one stabilization arm affixed to the body portion. The at least one stabilization arm may be configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth. The at least one stabilization arm may be affixed to a posterior region of the body portion. The at least one stabilization arm may be one of in contact with an anatomical structure of the patient or may be free floating from the anatomical structure. The body portion may include an outer surface and an inner surface, and wherein the passageway may extend from the outer surface through the inner surface of the body portion. The one or more connector bodies may include a connection sleeve, the connection sleeve may include a receiving port extending lengthwise at least partially therethrough. The connection sleeve may further include a coupling hole, the coupling hole may extend widthwise at least partially therethrough, and wherein the coupling hole may intersect with the receiving port of the connection sleeve. The one or more fixation ports may be configured to receive a fixation mechanism therethrough, and wherein the fixation mechanism may be configured for anchoring the foundation guide to a maxillary or mandibular bone of a patient. The fixation mechanism may include one or more of a fixation pin and/or a fixation screw. The body portion may further include protrusions formed on an inner surface of the main body and extending outward therefrom in a generally perpendicular direction. The protrusions may be disposed proximate to one or more of the one or more fixation ports. The body portion may include a first portion and a second portion, and wherein the first portion and the second portion may be coupled together at about a center point thereof in a hingeable manner. The first portion and the second portion may each include at least one of the one or more connector bodies, at least one of the one or more fixation ports, and wherein at least one of the first portion and/or the second portion may include at least one stabilization arm.

In another embodiment, a stackable foundation guide is provided. The stackable foundation guide may include a body portion having a first portion and a second portion, wherein the first portion and the second portion may be coupled together at about a center point thereof in a hingeable manner; one or more connector bodies spaced generally about the body portion; and one or more fixation ports spaced about the body portion, each of the one or more fixation ports forming a passageway therethrough. The first portion and the second portion may each include at least one of the one or more connector bodies and at least one of the one or more fixation ports. The stackable foundation guide may further include at least one stabilization arm affixed to at least one of the first portion and/or the second portion of the body portion. The at least one stabilization arm may be configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth. The at least one stabilization arm may be affixed to a posterior region of the body portion. The body portion may include an outer surface and an inner surface, and wherein the passageway extends from the outer surface through the inner surface of the body portion. The one or more connector bodies may include a connection sleeve, the connection sleeve may include a receiving port extending lengthwise at least partially therethrough. The connection sleeve may further include a coupling hole, the coupling hole may extend widthwise at least partially therethrough, and wherein the coupling hole may intersect with the receiving port of the connection sleeve. The one or more fixation ports may be configured to receive a fixation mechanism therethrough, and wherein the fixation mechanism may be configured for anchoring the foundation guide to a maxillary or mandibular bone of a patient. The fixation mechanism may include one or more of a fixation pin and/or a fixation screw. The body portion may further include protrusions formed on an inner surface of the main body and extending outward therefrom in a generally perpendicular direction. The protrusions may be disposed proximate to one or more of the one or more fixation ports.

In yet another embodiment, a method of using a stackable foundation guide is provided. The method may include providing a stackable foundation guide. The stackable foundation guide may include a body portion having a generally arcuate shape; one or more connector bodies spaced generally about the body portion; one or more fixation ports spaced about the body portion, each of the one or more fixation ports forming a passageway therethrough; and at least one stabilization arm affixed to the body portion, wherein the at least one stabilization arm may be configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth. The method may further include fixating the stackable foundation guide to a patient's anatomy. The method may further include performing a planned surgical procedure using one or more guide components and removing the stackable foundation guide upon completion of the planned surgical procedure. The body portion may include a first portion and a second portion, and wherein the first portion and the second portion may be coupled together at about a center point thereof in a hingeable manner.

In still yet another embodiment, a method of using a stackable foundation guide is provided. The method may include providing a stackable foundation guide. The stackable foundation guide may include a body portion having a first portion and a second portion, wherein the first portion and the second portion may be coupled together at about a center point thereof in a hingeable manner; one or more connector bodies spaced generally about the body portion; and one or more fixation ports spaced about the body portion, each of the one or more fixation ports forming a passageway therethrough. The method may further include fixating the stackable foundation guide to a patient's anatomy. Fixating the stackable foundation guide to the patient's anatomy may include pivoting the first portion and the second portion of the body portion to a first open position and then once the stackable foundation guide is orientated in the patient's mouth pivoting the first portion and the second portion of the body portion to a second closed position, and then installing one or more fixation mechanisms through the one or more fixation ports into a maxillary or mandibular bone of a patient. The stackable foundation guide may further include at least one stabilization arm affixed to at least one of the first portion and the second portion of the body portion, wherein the at least one stabilization arm may be configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth. The method may further include performing a planned surgical procedure using one or more guide components and removing the stackable foundation guide upon completion of the planned surgical procedure.

### BRIEF DESCRIPTION OF THE DRAWINGS

Having thus described the subject matter of the invention in general terms, reference will now be made to the accompanying drawings, which are not necessarily drawn to scale, and wherein:

FIGS. 1-3 illustrate various views of an example of a stackable foundation guide, in accordance with an embodiment of the invention;

FIG. 4 illustrates an example of the stackable foundation guide seated on an example model of a patient's bone, in accordance with an embodiment of the invention;

FIG. 5 illustrates a cross-sectional view of an example of the stackable foundation guide seated on an example model of a patient's bone along line 5-5 of FIG. 4, in accordance with an embodiment of the invention;

FIG. 6 illustrates an example of the stackable foundation guide seated on an example model of a patient's bone including the patient's preoperative teeth, in accordance with an embodiment of the invention;

FIG. 7 illustrates a top view of an example mandibular bone model showing example bone seating sites in isolation, in accordance with an embodiment of the invention;

FIG. 8 illustrates a detailed view of an example attachment between a seating site portion of the stackable foundation guide, in accordance with an embodiment of the invention;

FIGS. 9-13 illustrate various views of a stackable foundation guide, in accordance with an embodiment of the invention;

FIGS. 14-18 illustrate various views of a stackable foundation guide, in accordance with an embodiment of the invention;

FIG. 19 illustrates an example stackable foundation guide, in accordance with an embodiment of the invention;

FIG. 20 illustrates an example stackable foundation guide, in accordance with an embodiment of the invention;

FIG. 21 illustrates an example stackable foundation guide, in accordance with an embodiment of the invention;

FIG. 22 illustrates a front view of the example stackable foundation guide of FIG. 21, in accordance with an embodiment of the invention;

FIG. 23 illustrates a top view of a hinged stackable foundation guide, in accordance with an embodiment of the invention;

FIGS. 24-26 illustrate various views of a first portion of the hinged stackable foundation guide, in accordance with an embodiment of the invention;

FIGS. 27-29 illustrate various views of a second portion of the hinged stackable foundation guide, in accordance with an embodiment of the invention;

FIGS. 30-31 illustrate various views of the hinged stackable foundation guide, in accordance with an embodiment of the invention;

FIG. 32 illustrates a top view of the hinged stackable foundation guide in an open position, in accordance with an embodiment of the invention;

FIG. 33 illustrates a top view of the hinged stackable foundation guide in a closed position on an example bone model, in accordance with an embodiment of the invention;

FIG. 34 illustrates another top view of the hinged stackable foundation guide in a closed position on an example bone model, in accordance with an embodiment of the invention;

FIG. 35 illustrates a front view of the hinged stackable foundation guide in a closed position on an example bone model, in accordance with an embodiment of the invention;

FIG. 36 illustrates the first portion and second portion of hinged stackable foundation guide in a disconnected state, in accordance with an embodiment of the invention;

FIG. 37 illustrates the hinged stackable foundation guide in an example stacked assembly on an example bone model, in accordance with an embodiment of the invention; and

FIG. 38 illustrates an example hinged stackable foundation guide, in accordance with an embodiment of the invention.

### DETAILED DESCRIPTION

The subject matter of the invention now will be described more fully hereinafter with reference to the accompanying drawings, in which some, but not all embodiments of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a stackable surgical foundation guide including one or more stabilization arms that may be, for example, on the superior and inferior surfaces of the mandible and maxilla, respectively, extending across the top of and/or behind the maxillary or mandibular bone structure of a patient. The one or more stabilization arms may extend to the top of, or past, the crestal aspect of the residual ridge of an edentulous patient's mouth or behind, or in the back of, one or more tooth structures on the crestal aspect of the residual ridge of a dentate patient's mouth, and may touch the patient's anatomy or be free floating in those anatomical areas

Using the subject stackable foundation guide, surgery may be performed on dentate or edentulous patients, and with or without tissue reflection in both types of patients. The subject stackable foundation guide limits the amount of tissue reflection necessary to perform intra-oral surgery. Further, the subject stackable foundation guide may be flat planed or scalloped for bone contouring and reduction. The subject stackable foundation guide significantly reduces the invasive nature of intra-oral and dental implant surgical procedures. The subject stackable foundation guide with one or more stabilization arms may also improve stabilization of the stackable foundation guide during its installation and use during, for example, intra-oral surgical procedures.

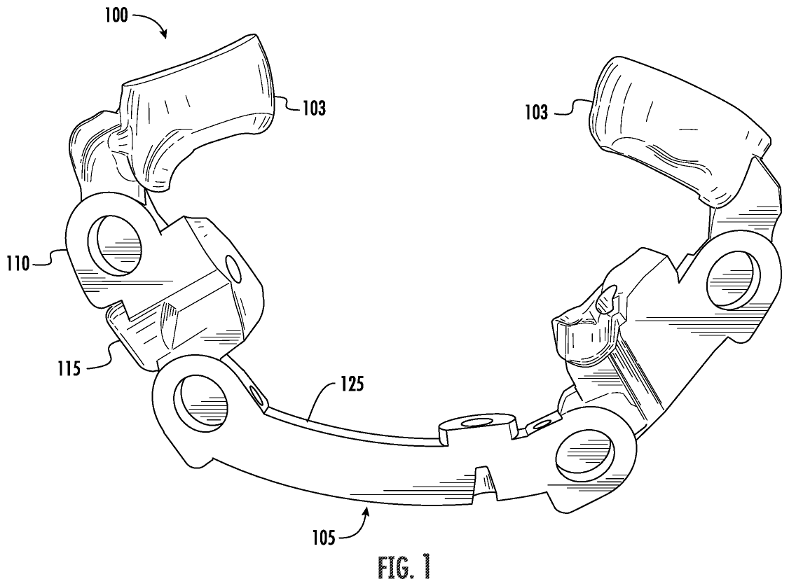

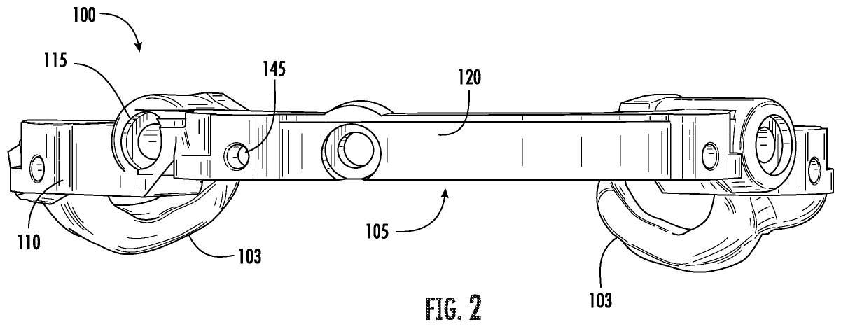

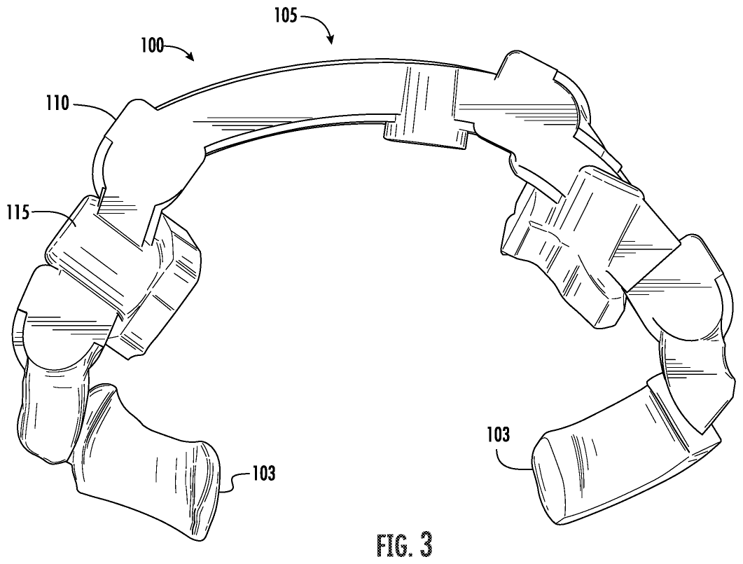

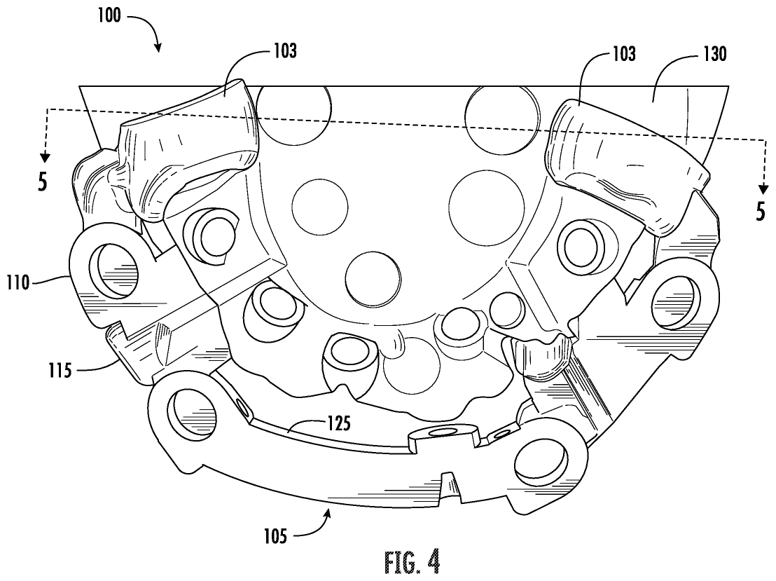

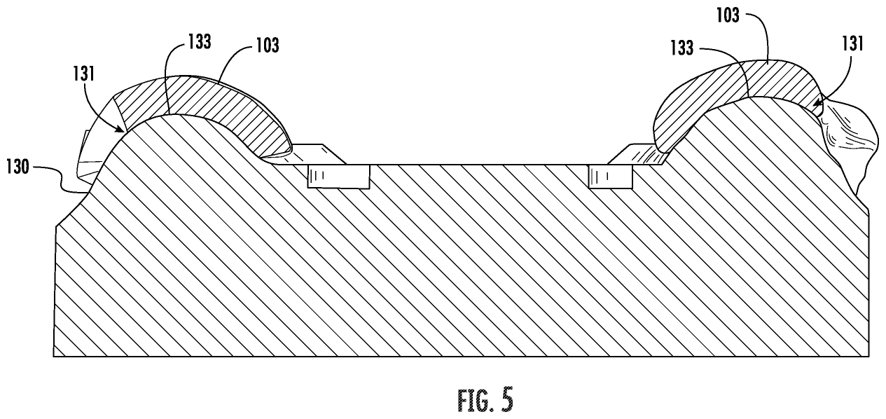

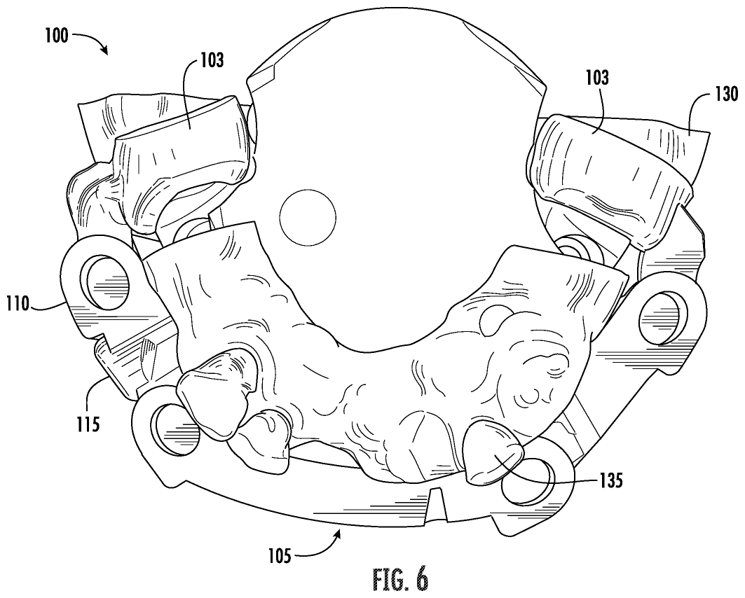

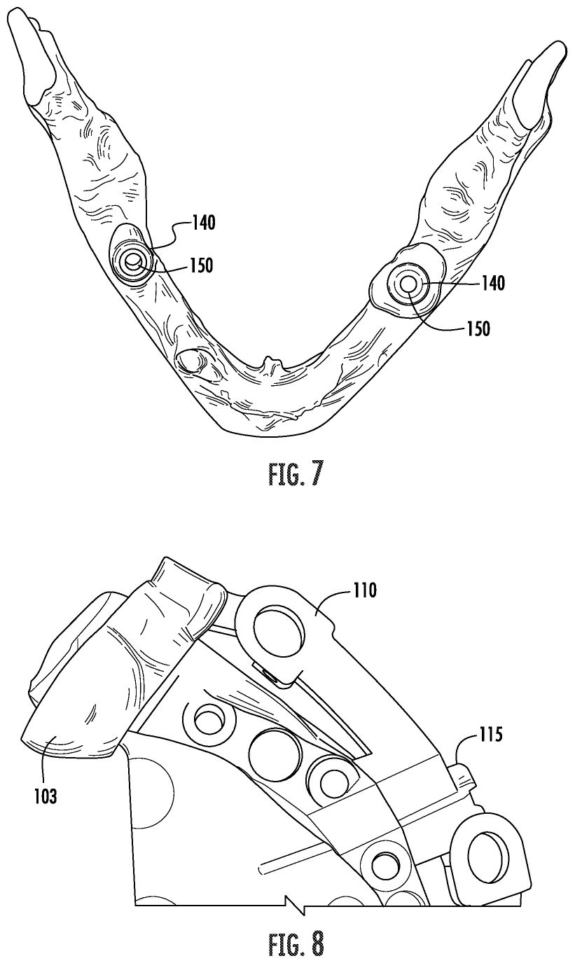

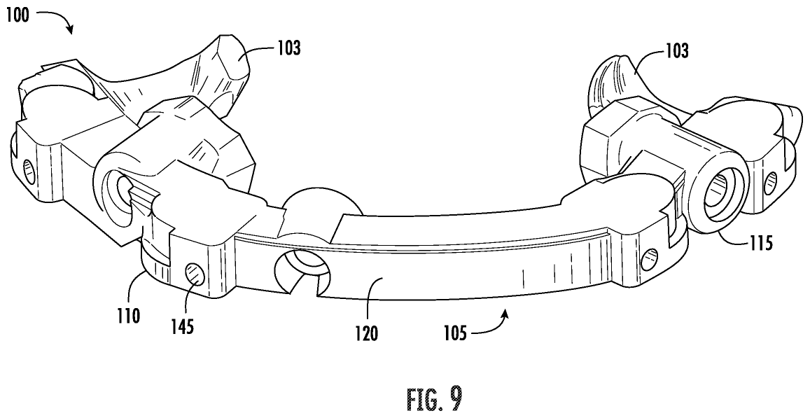

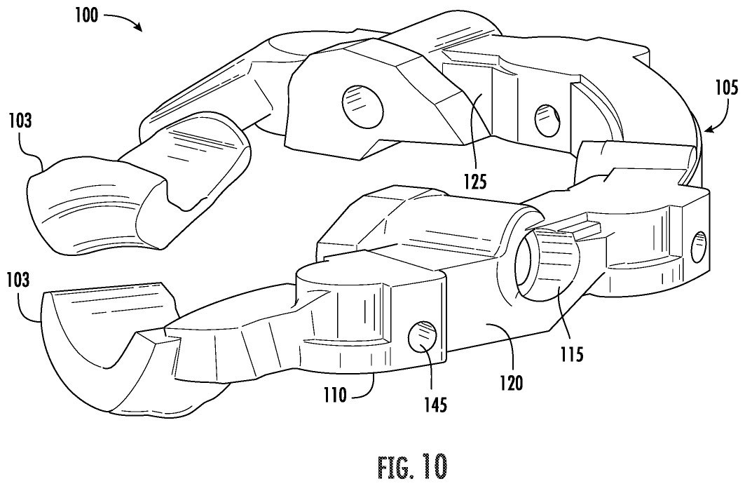

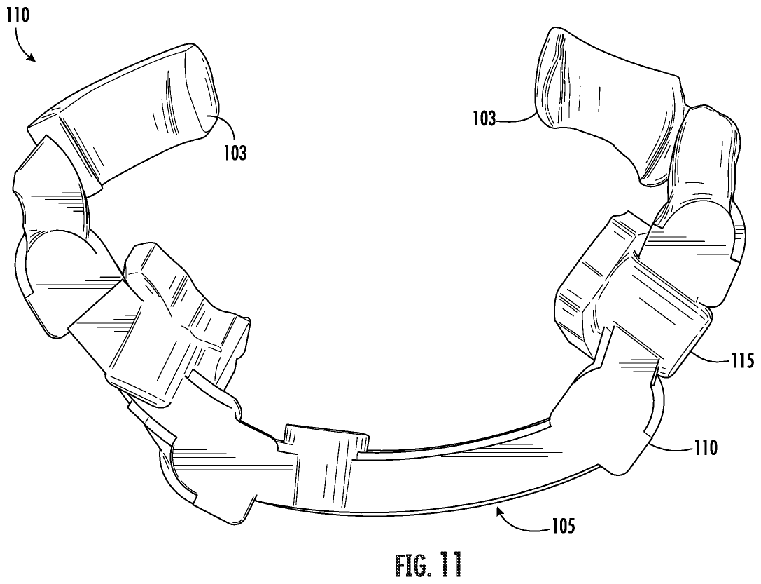

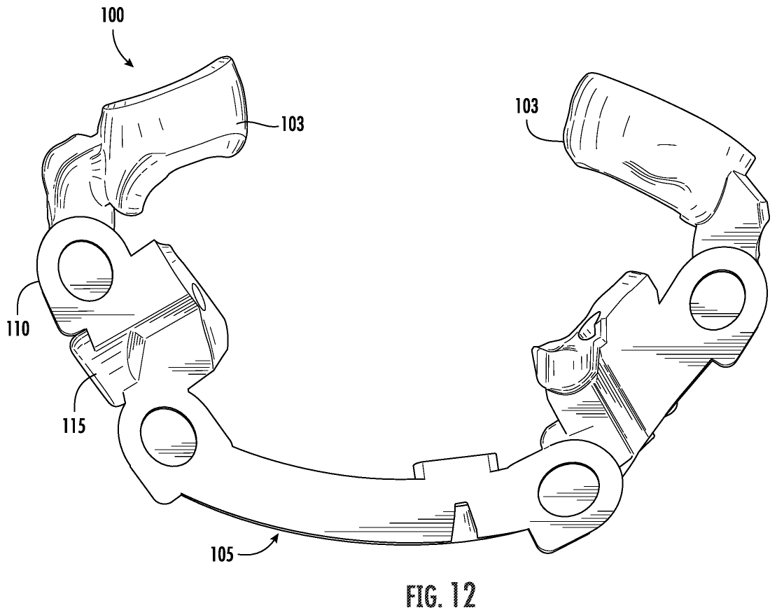

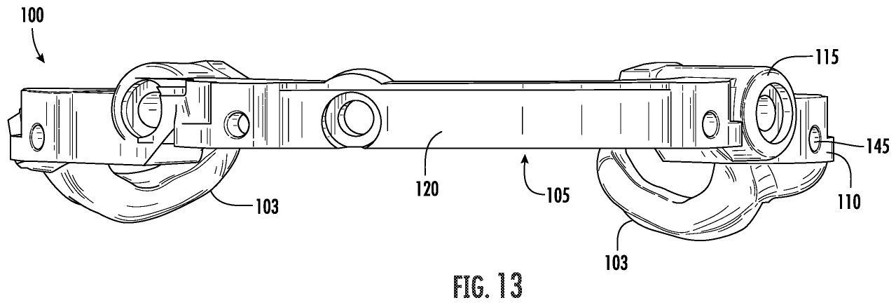

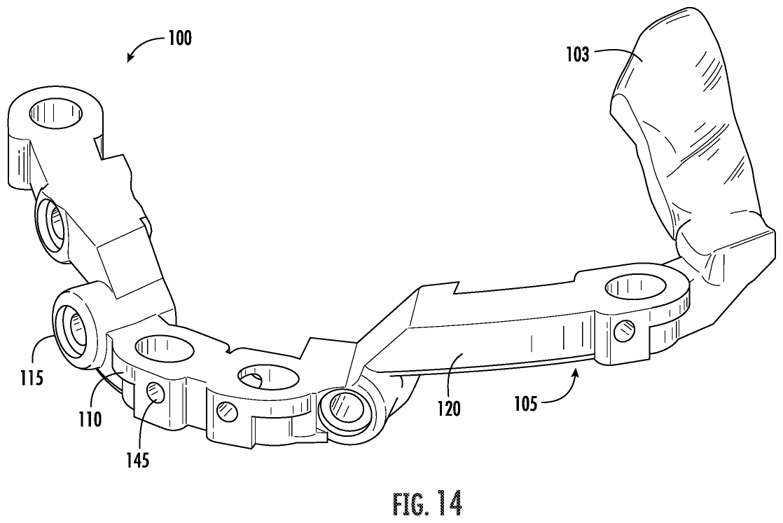

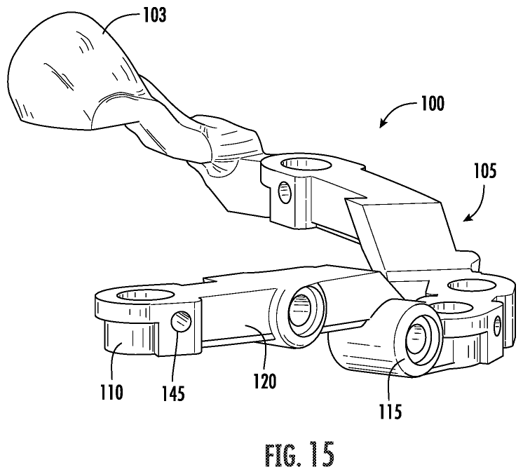

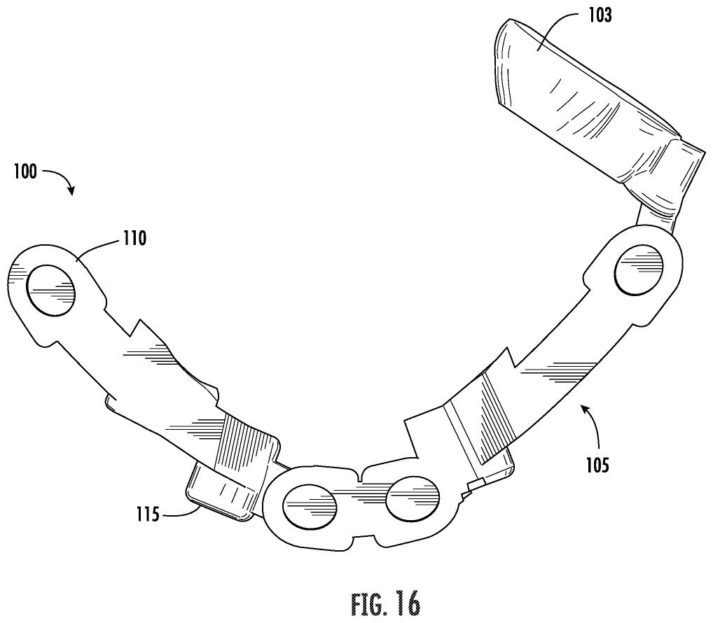

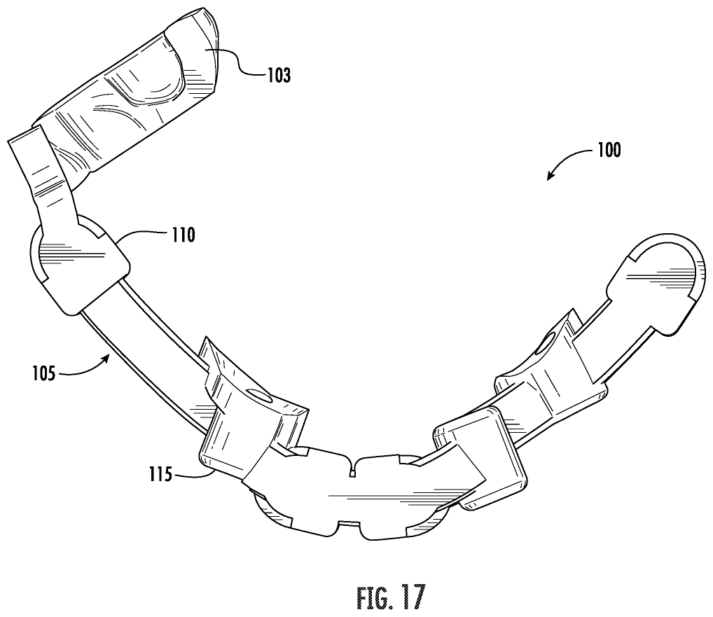

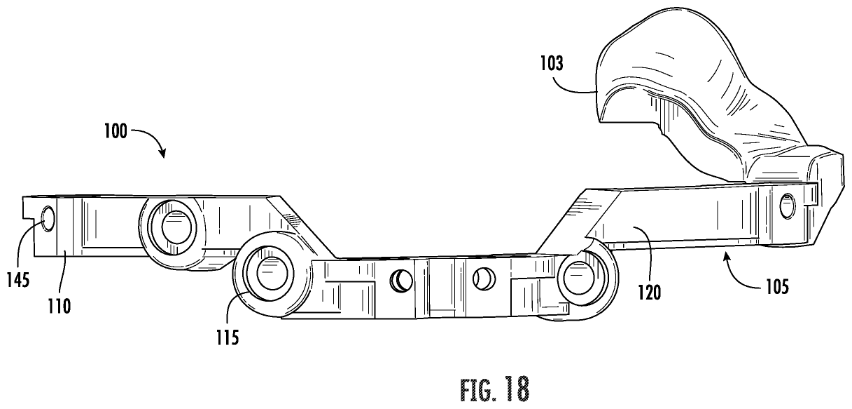

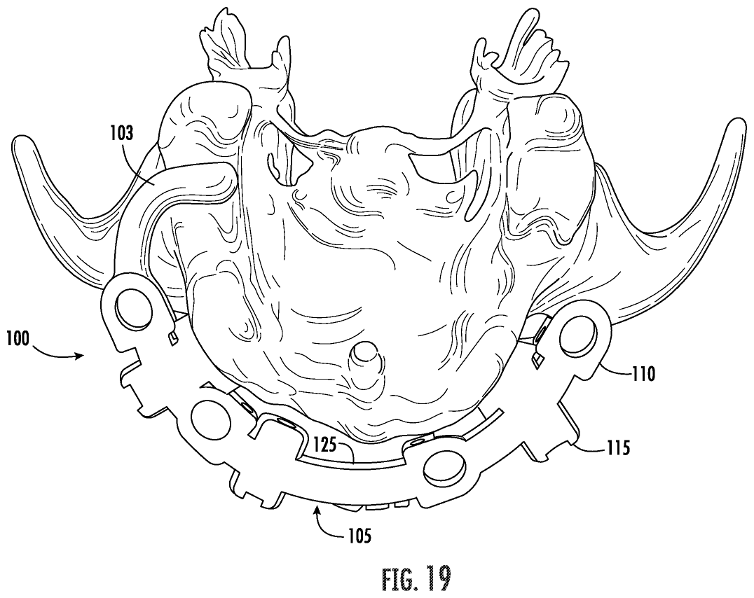

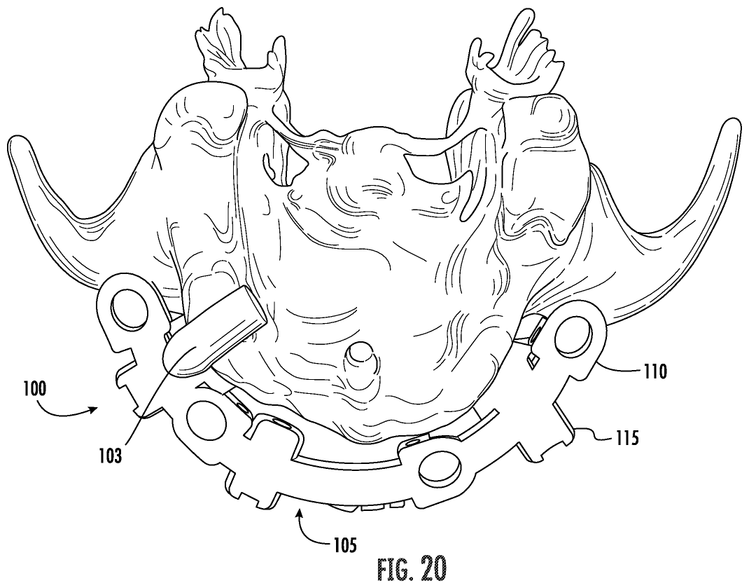

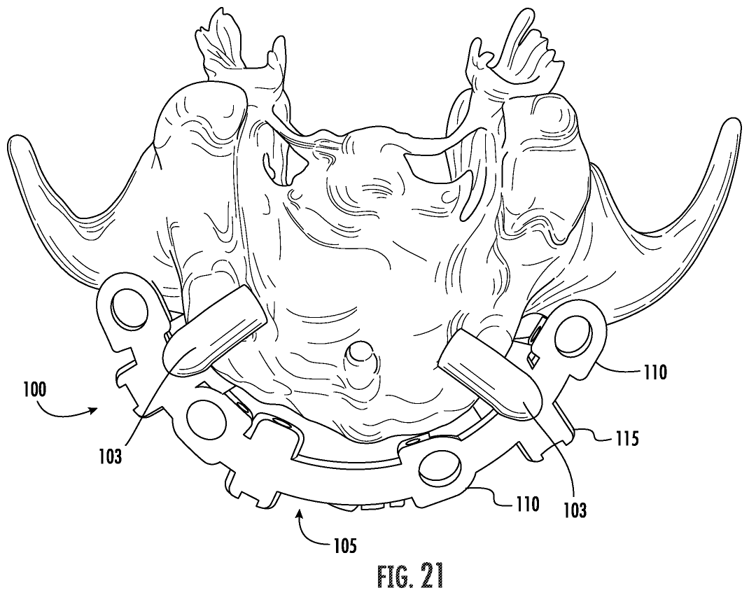

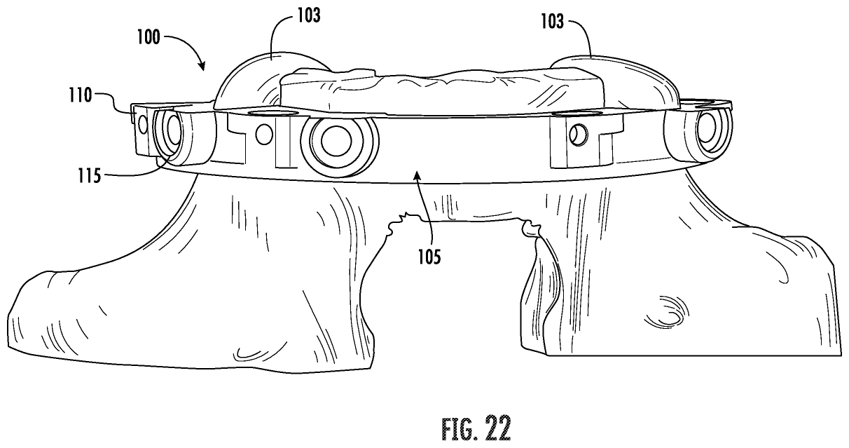

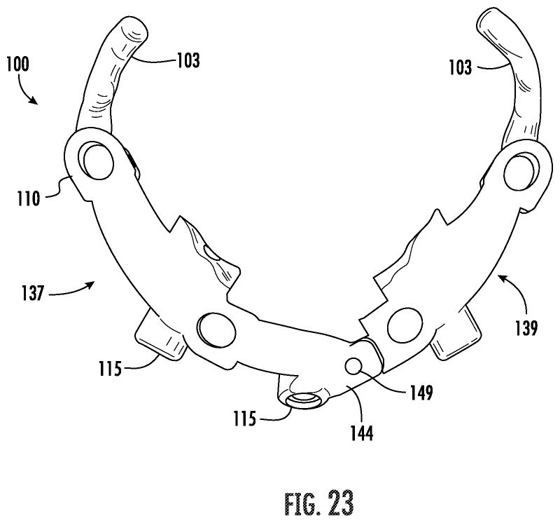

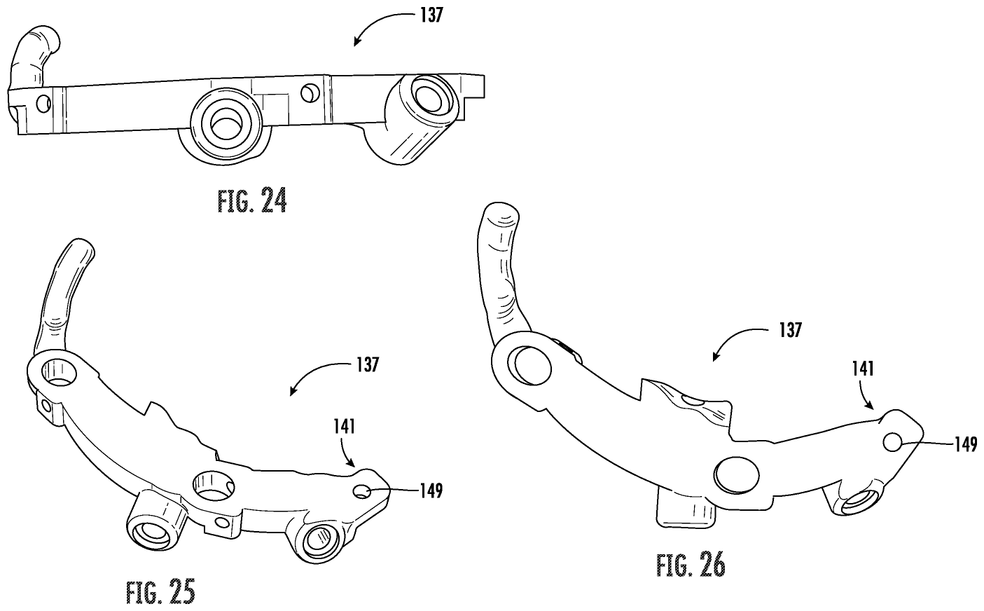

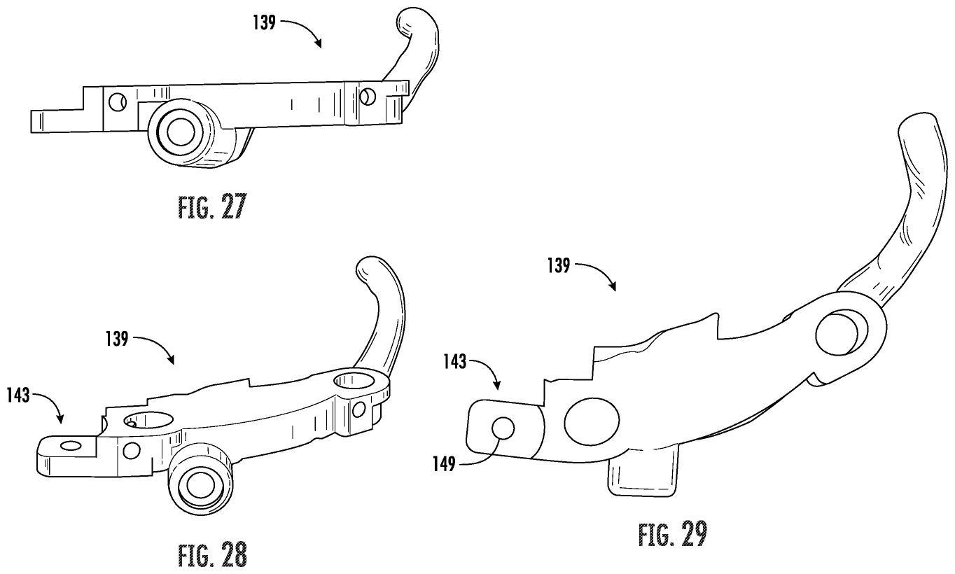

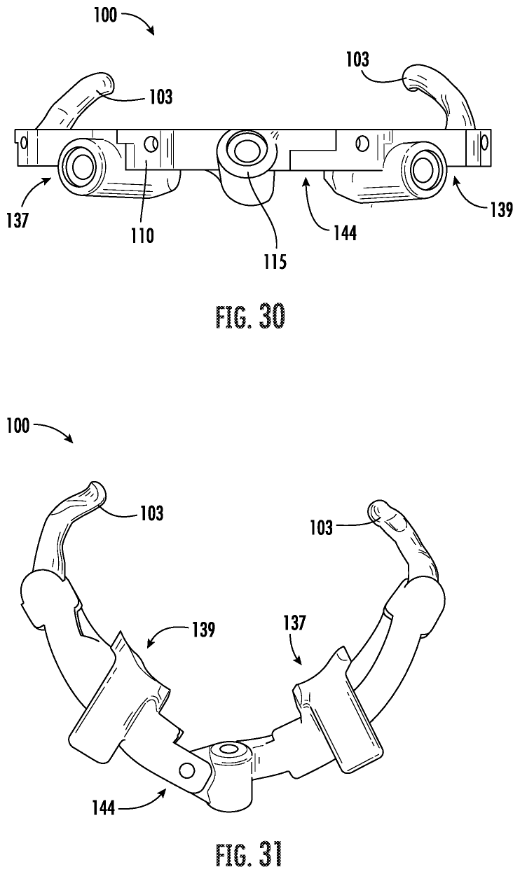

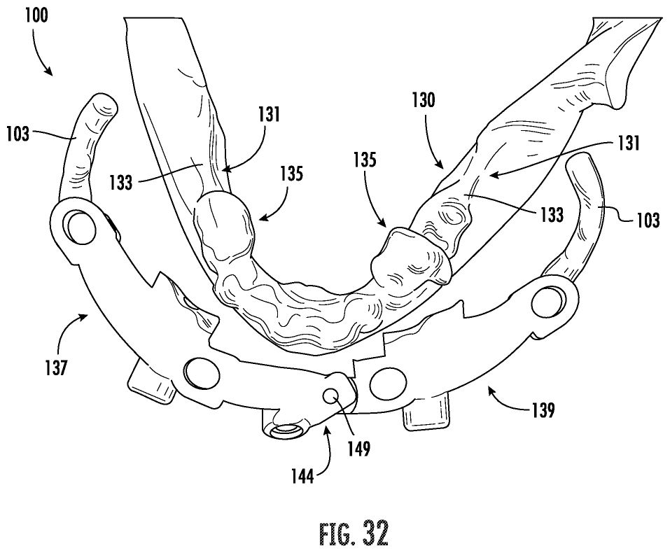

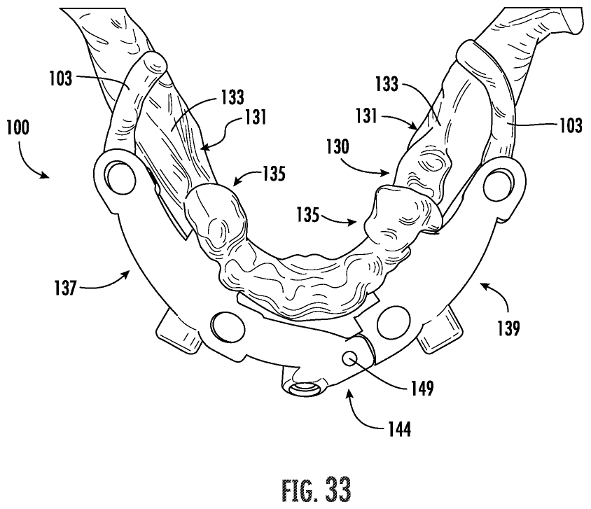

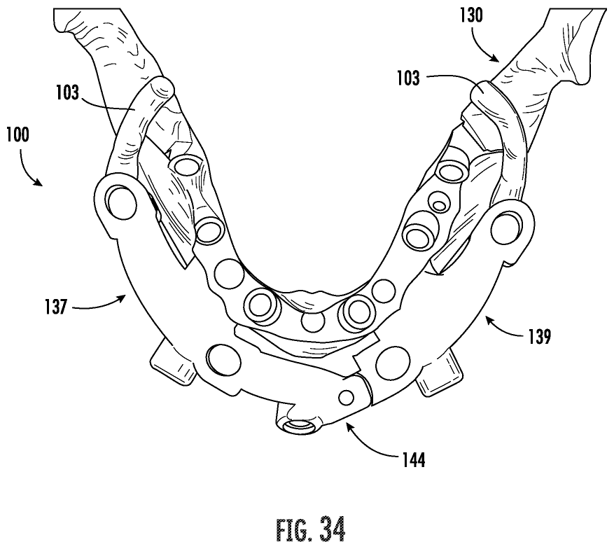

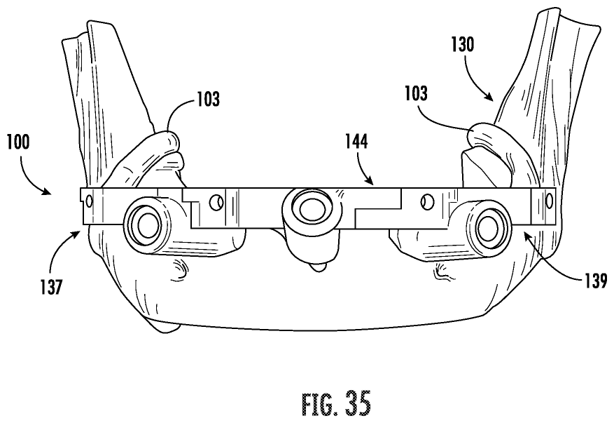

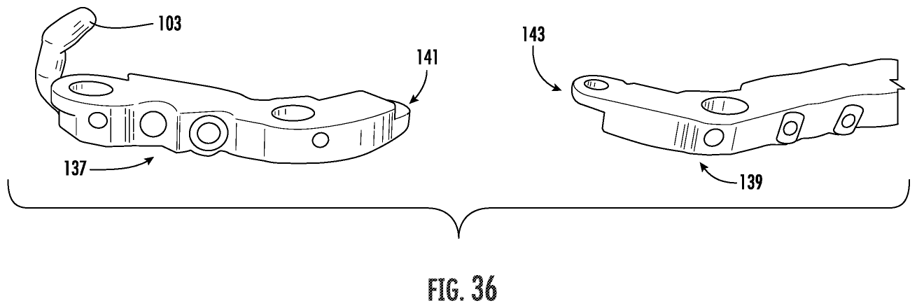

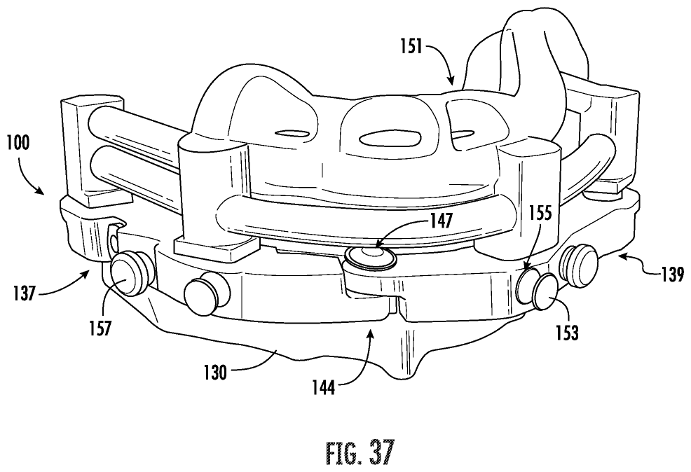

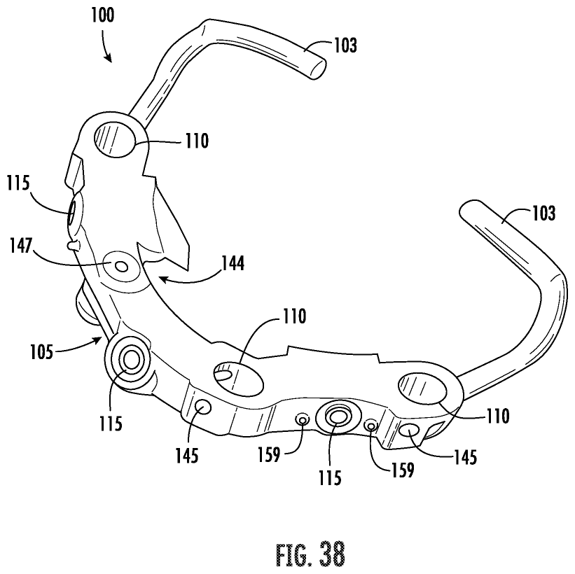

Referring now to FIGS. 1-3, illustrate various views of an example fixation base frame 100. FIG. 4 shows an example of the fixation base frame 100 seated on an example model of a patient's bone structure 130. FIG. 5 shows a cross-sectional view of surgical guide 100 taken along line 5-5 of FIG. 4. FIG. 6 shows an example of the fixation base frame 100 seated on an example model of a patient's bone structure 130 including the patient's preoperative teeth 135. FIG. 7 shows a top view of an example mandibular bone model showing an example of bone seating fixation site 140 for use as a fixation site. FIG. 8 shows a top detailed view of a region where a stabilization arm 103 connects to fixation base frame 100. FIGS. 9-13 show various views of another example of fixation base frame 100, for example, for seating on a patient's maxillary bone structure. FIGS. 14-18 show various views of yet another example of the fixation base frame 100 having one stabilization arm 103, for example, for seating on a patient's mandibular bone structure. FIG. 19 shows another example of fixation base frame 100 with a stabilization arm 103 that extends at least across the top of and/or behind the maxillary or mandibular bone structure of a patient. FIG. 20 shows another example of fixation base frame 100 with a stabilization arm 103 that extends at least across the top of and/or behind the maxillary or mandibular bone structure of a patient at an alternate position of that shown in FIG. 19. FIG. 21 shows another example of fixation base frame 100 similar to that shown in FIG. 20, and including two stabilization arms 103 each extending at least across the top of and/or behind the maxillary or mandibular bone structure of a patient. FIG. 22 shows a front view of the example stackable foundation guide of FIG. 21. FIG. 23 shows a top view of a stackable foundation guide 100 including a first hinged portion 137 and a second hinged portion 139. FIGS. 24-26 show various views of a first hinged portion 137 of the hinged stackable foundation guide 100. FIGS. 27-29 show various views of a second hinged portion 139 of the hinged stackable foundation guide 100. FIGS. 30-31 show various views of the stackable foundation guide 100 including a first hinged portion 137 and a second hinged portion 139. FIG. 32 shows a top view of the stackable foundation guide 100 including a first hinged portion 137 and a second hinged portion 139 in an open position. FIG. 33 shows a top view of the stackable foundation guide 100 including a first hinged portion 137 and a second hinged portion 139 in a closed position on an example bone model. FIG. 34 shows another top view of the hinged stackable foundation guide 100 in a closed position on an example bone model. FIG. 35 shows a front view of the stackable foundation guide 100 including a first hinged portion 137 and a second hinged portion 139 in a closed position on an example bone model. FIG. 36 shows the first hinged portion 137 and second hinged portion 139. FIG. 37 shows the stackable foundation guide 100 including a first hinged portion 137 and a second hinged portion 139 in an example stacked assembly on an example bone model. FIG. 38 shows another example of the hinged stackable foundation guide 100 with stabilization arms 103.

With reference to the figures, in one example, fixation base frame 100 may include a main body 105, which may be generally arcuate/curved, for example, in the general shape of a patient's gum line. Main body 105 may include connection sleeves 110 (aka plug connectors) spaced about the main body 105, and may further include fixation ports 115 spaced about the main body 105. Fixation ports 115 may form a passage through the main body 105 extending from the outer surface 120 through an inner surface 125 of the main body 105. The connection sleeves 110 and fixation ports 115 may be evenly spaced apart in an alternating manner, may be spaced at irregular intervals, and/or may or may not be configured in an alternating arrangement with each other.

Fixation base frame 100 may further include one or more stabilization arms 103. In one embodiment, for example as shown in FIGS. 4-6, the one or more stabilization arms 103 may extend across the top of and/or behind the maxillary or mandibular bone structure 130 of a patient. The stabilization arms 103, in one example, may seat on the superior and inferior surfaces of the mandible and maxilla, respectively, extending across the top of and/or behind the maxillary or mandibular bone structure 130 of a patient. In one example, in an edentulous patient, at least a portion of the one or more stabilization arms 103 may extend to a top of, or past, a crestal aspect 133 of a residual ridge 131 of the edentulous patient's mouth. In one example, in a dentate patient, at least a portion of the one or more stabilization arms 103 may extend behind, or in back of, one or more tooth structures 135 on the crestal aspect 133 of the residual ridge 131 of the dentate patient's mouth. In one example, the stabilization arms 103, when in installed in a patient's mouth, may be in the posterior region of the patient's mouth, along the alveolar process, and, for example, in the region of the maxillary or mandibular tuberosities. It may be necessary, in some cases, to extract a tooth or use an edentulous area in other positions in the arch other than in the posterior area of a patient's mouth in the region of the maxillary or mandibular tuberosities. Accordingly, in another example, the one or more stabilization arms 103, may be positioned anywhere around the arch when installed in a patient's mouth (as shown for example in, but not limited to, FIGS. 20-22), and not limited to, for example, the retromolar pad or hamular notch area.

Fixation base frame 100 may include a stabilization arm 103 on one or both sides of the fixation base frame 100. The one or more stabilization arms 103 and fixation base frame 100 may be formed or manufactured as a single piece. Alternatively, fixation base frame 100 may not include a stabilization arm 103, or the one or more stabilization arms 103 may be added to the fixation base frame 100.

With reference to FIGS. 23-38, in another example, fixation base frame 100 may include two hinged portions, a first hinged portion 137 and a second hinged portion 139. First hinged portion 137 and second hinged portion 139 may include a first hinge component 141 and a second hinge component 143, respectively. First hinge component 141 and second hinge component 143, of first hinged portion 137 and second hinged portion 139 respectively, may be joined at a hinge site 144 by use of a hinge fastener 147, such as shown for example in FIG. 37, or any other suitable type fastener. The first hinge component 141 and second hinge component 143 may each include a hinge connector hole 149. In one example, each of the hinge connector holes 149 are configured, such that when in an installed configuration each hinge connector hole 149 of the first hinge component 141 and second hinge component 143 align with one another, such that hinge fastener 147 may be passed through the aligned hinge connector holes 149 to secure the first hinged portion 137 and second hinged portion 139 together in a hingeable fashion. The connection of first hinge component 141 and second hinge component 143 by use of hinge fastener 147, for example, joins the first hinged portion 137 and second hinged portion 139 of the fixation base frame 100, and allows at least some degree of rotation about the axis of hinge connector hole 149.

With further reference to FIGS. 32-35, installation of the fixation base frame 100, including first hinged portion 137 and second hinged portion 139, within a patient's mouth, may be conducted, in one example, by pivoting the first hinged portion 137 and second hinged portion 139 about the axis of hinge connector hole 149, as shown for example in FIG. 32 (the ‘open’ position), allowing stabilization arms 103 (if present) to pass around structures in the oral cavity such as teeth 135, and when pivoted into position as depicted in FIG. 33 (the ‘closed’ position), allows stabilization arms 103 (if present) to seat on the patient's bone structure 130.

With further reference to FIG. 37, an example assembly process is illustrated. In this non-limiting example, a guide, such as an alignment guide 151, may be latched into the fixation base frame 100, including first hinged portion 137 and second hinged portion 139, and fastened by use of inserting, for example, a latch pin 153 into a latch pin hole 155 (aka coupling pin hole 145) of connection sleeves 110. The fixation base frame 100, including first hinged portion 137 and second hinged portion 139, may be fastened to the patient's bone structure 130 by use of, for example, fixation pins 157 (or screws) passed through fixation ports 115. Hinge fastener 147 may be passed through the aligned hinge connector holes 149 of first hinge component 141 and second hinge component 143, at hinge site 144, thereby creating a hinge between first hinged portion 137 and second hinged portion 139. However, it should be noted that the design of this hinge and fastener could be of any suitable style that would allow first hinged portion 137 and second hinged portion 139 to hinge relative to one another.

Fixation base frame 100, including first hinged portion 137 and second hinged portion 139 provides an improved ability for seating the fixation base frame 100. In some instances, it may be difficult to maneuver a fixation base frame into position in a patient's mouth, as certain components, e.g., seating sites 103, may conflict with structures in the patient's mouth such as bone, teeth, and/or tissue. The fixation base frame 100, including first hinged portion 137 and second hinged portion 139, improves on this issue by including a hinge, allowing the two portions of the fixation base frame 100 (i.e., first hinged portion 137 and second hinged portion 139) to hinge relative to one another and thereby maneuver more easily into position while avoiding conflicting structures in the patient's mouth.

In one embodiment, foundation guide 100 may be seated and anchored (fixated) in place by anchoring to the maxillary or mandibular bone structure 130 of a patient via fixation pins and/or screws (such as fixation pins 157 as shown for example in FIG. 37) inserted through one or more of the fixation ports 115. This fixation may be done a number of different ways, for example, as disclosed in U.S. patent application Ser. No. 16/869,717 entitled “Tissue Borne Fixation System, Device, and Methods of Making and Using Same”, as disclosed in U.S. patent application Ser. No. 16/869,698 entitled “Tissue Borne Stackable Foundation Guide and Method of Making and Using Same”, the entire disclosures of which are incorporated herein by reference, or any other suitable mechanism or technique of affixing a foundation guide to a patient's bony surface.

Fixation base frame 100 may be stacked with a stackable component (e.g., alignment guide 151 as shown for example in FIG. 37) via one or more of the connection sleeves 110. Connection sleeves 110 are preferably sized and shaped, such that they may receive a corresponding connection post (e.g., jack connector) of the stackable component. In one example, one or more of connection sleeves 110 of the fixation base frame 100 may include a coupling pin hole 145 (aka latch pin hole 155). The coupling pin hole 145, when the fixation base frame 100 and the stackable component are in the stacked configuration, is configured such that the coupling pin hole 145 aligns with a corresponding coupling pin hole of the corresponding connection post of the stackable component. The fixation base frame 100 and the stackable component may be secured in the stacked configuration by one or more coupling pins (such as latch pins 153 shown for example in FIG. 37), inserted in corresponding one or more of coupling pin holes 145 and coupling pin holes of the stackable component. Foundation guide 100 and the stackable component may be stacked and secured together using any other suitable technique or mechanism, and is not limited to the connection sleeve 110 and connection post configuration described above.

In use, a surgeon may expose bone of a patient at fixation sites and/or seating sites. In most cases, there would be available bone on which to seat the stabilization arms 103. However, if not, the surgeon may extract one or more posterior teeth 135, or other teeth 135 as necessary, to provide sufficient bone structure on which to seat the stabilization arms 103.

The fixation base frame 100, in one example, may be delivered by an alignment guide (e.g., alignment guide 151). For example, as disclosed in either or both of: U.S. Patent Pub. No. 2020/0352736 A1, entitled “Tissue Borne Stackable Foundation Guide and Method of Making and Using Same,” and U.S. Patent Pub. No. 2020/0352679 A1, entitled “Tissue Borne Fixation System, Device, and Methods of Making and Using Same,” which are both incorporated herein in their entirety. Delivery and seating of a stackable foundation guide, verified with an alignment guide and fixation sites provides dual-verification of the stackable foundation guide's seating position. That is, the seating position of the stackable foundation guide is verified by using both the alignment guide and fixation sites. However, using the fixation base frame 100 with stabilization arms 103, the stabilization arms 103 provide an additional verification site. Therefore, using the fixation base frame 100, provides triple verification of the stackable foundation guide's seating position (i.e., alignment guide, fixation sites, and stabilization arms 103). Once triple verification has been confirmed, the surgeon may fixate the fixation base frame 100 with a very high degree of certainty it is properly seated, and then can remove the alignment guide. The surgery may then progress according to the appropriate protocol for the surgery being performed. During surgery, the stabilization arms 103 additionally provide stability to the fixation base frame 100, e.g., along its anterior-posterior axis.

In another example, and with reference to FIG. 7, one or more stabilization arms 103 may also be used as a fixation site (e.g., bone seating fixation site 140) for the fixation base frame 100. In such an example, one or more of the stabilization arms 103 may be treated in a similar fashion as the fixation ports 115. In this example, a hole may be formed through at top portion of the one or more stabilization arms 103 creating a bone seating fixation site 140 to be used for fixation. A sleeve 150 (e.g., a metal or other suitable material sleeve) may be inserted in the formed hole and cemented therein, or otherwise secured in place, and a fixation pin or screw may be inserted through the sleeve 150 and into the bone structure 130.

The stabilization arms 103 of the fixation base frame 100 provide clinicians increased confidence in guide seating and stability during a surgical procedure. Such improved stability may be useful when, for example, running tools along a guide, when, for example, drilling osteotomies, adjusting a temporary, and/or other scenarios in which a guide may be moved out of position during a surgical procedure.

The fixation base frame 100, including any one or more of its components, may be made of polymers, fiber reinforced material, Teflon reinforced nylon, carbon reinforced nylon polymer, nylon, fiberglass, HSHT fiberglass, carbon fiber, onyx, Kevlar, cobalt chrome, polymers, alloys, zirconias, printed resin material, nylon carbon fiber reinforced, any other suitable material and/or combinations thereof. The fixation base frame 100, including any one or more of its components, may be formed by printing, milling, casting, and/or any other suitable method/technique or combinations thereof. The printing, milling, and/or casting of the foundation guide may be accomplished using various techniques/methods, e.g., axis milling systems, selective laser milling, digital laser milling, printed with resin based printer, centrifugal casted, digital precision metals (DPM), direct metal laser sintering (DMLS), and/or any other suitable methods and/or techniques and/or combinations thereof. Further, the fixation base frame 100 may be digitally designed with various suitable software packages and analog processed off, for example but not limited to, STL digital design files. The fixation base frame 100, including any one or more of its components, may be formed of and/or utilizing fiber-reinforced high-performance thermoplastics, for example, but not limited to, carbon fiber reinforced thermoplastic material, and methods.

Fixation base frame 100 may further include a reference block (not shown), e.g., robotic reference attachment (RRA) or latched robotic reference attachment (LRRA), such as described in related U.S. patent application Ser. No. 17/469,435, entitled “Bone Stabilized Base Guide and Method for Attaching and Positioning a Robotic Intra-Oral Surgical Device”, the entire disclosure of which is incorporated herein by reference.

Fixation base frame 100 may further include one or more tissue thickness indicators (not shown), such as described in related U.S. patent application Ser. No. 16/869,698 (U.S. Patent Pub. No. 2020/0352736 A1), entitled “Tissue Borne Stackable Foundation Guide and Method for Method of Making and Using Same”, the entire disclosure of which is incorporated herein by reference.

Fixation base frame 100 may further include fiducial markers (IFMs) 159 and/or integrated scanning indices (not shown), such as described in related U.S. Provisional Patent App. No. 63/406,345, entitled “Intra-Oral Scan Indexing System and Method”, the entire disclosure of which is incorporated herein by reference.

Further, methods of modeling, making, and/or using (including planning and/or conducting of a procedure), the fixation base frame 100 and/or any one or more of its components may be substantially as disclosed in any one or more of: U.S. Patent Pub. No. 2020/0352736 A1, entitled “Tissue Borne Stackable Foundation Guide and Method of Making and Using Same”; U.S. Patent Pub. No. 2020/0352679 A1, entitled “Tissue Borne Fixation System, Device, and Methods of Making and Using Same”; and U.S. Provisional Patent App. No. 63/282,305, entitled “Surgical Guides Formed of Fiber-Reinforced High-Performance Thermoplastics and Methods”, the entire disclosures of which are incorporated herein by reference.

Further still, the fixation base frame 100 may be used with (stackable with), and in the same or similar manner, as any one or more of the stackable components (stackable guides) disclosed in any one or more of: U.S. Patent Pub. No. 2020/0352736 A1, entitled “Tissue Borne Stackable Foundation Guide and Method of Making and Using Same”; U.S. Patent Pub. No. 2020/0352679 A1, entitled “Tissue Borne Fixation System, Device, and Methods of Making and Using Same”; and U.S. Provisional Patent App. No. 63/282,305, entitled “Surgical Guides Formed of Fiber-Reinforced High-Performance Thermoplastics and Methods”, the entire disclosures of which are incorporated herein by reference.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A stackable foundation guide, comprising:
a. a body portion having a generally arcuate shape;
b. one or more connector bodies spaced generally about the body portion;
c. one or more fixation ports spaced about the body portion, each of the one or more fixation ports forming a passageway therethrough; and
d. at least one stabilization arm affixed to the body portion.

2. The stackable foundation guide of claim 1, wherein the at least one stabilization arm is configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth.

3. The stackable foundation guide of claim 1, wherein at least one stabilization arm is affixed to a posterior region of the body portion.

4. The stackable foundation guide of claim 1, wherein the at least one stabilization arm is one of in contact with an anatomical structure of the patient or is free floating from the anatomical structure.

5. The stackable foundation guide of claim 1, wherein the body portion comprises an outer surface and an inner surface, and wherein the passageway extends from the outer surface through the inner surface of the body portion.

6. The stackable foundation guide of claim 1, wherein each of the one or more connector bodies comprise a connection sleeve, the connection sleeve comprising a receiving port extending lengthwise at least partially therethrough.

7. The stackable foundation guide of claim 6, wherein each connection sleeve further comprises a coupling hole, the coupling hole extending widthwise at least partially therethrough, and wherein the coupling hole intersects with the receiving port of the connection sleeve.

8. The stackable foundation guide of claim 1, wherein the one or more fixation ports are configured to receive a fixation mechanism therethrough, and wherein the fixation mechanism is configured for anchoring the foundation guide to a maxillary or mandibular bone of a patient.

9. The stackable foundation guide of claim 8, wherein the fixation mechanism comprises one or more of a fixation pin and/or a fixation screw.

10. The stackable foundation guide of claim 1, wherein the body portion further comprises protrusions formed on an inner surface of the main body and extending outward therefrom in a generally perpendicular direction.

11. The stackable foundation guide of claim 10, wherein the protrusions are disposed proximate to one or more of the one or more fixation ports.

12. The stackable foundation guide of claim 1, wherein the body portion comprises a first portion and a second portion, and wherein the first portion and the second portion are coupled together at about a center point thereof in a hingeable manner.

13. The stackable foundation guide of claim 12, wherein the first portion and the second portion each comprise at least one of the one or more connector bodies, at least one of the one or more fixation ports, and wherein at least one of the first portion and/or the second portion comprise at least one stabilization arm.

14. A stackable foundation guide, comprising:
a. a body portion having a first portion and a second portion, wherein the first portion and the second portion are coupled together at about a center point thereof in a hingeable manner;
b. one or more connector bodies spaced generally about the body portion; and
c. one or more fixation ports spaced about the body portion, each of the one or more fixation ports forming a passageway therethrough.

15. The stackable foundation guide of claim 14, wherein the first portion and the second portion each comprise at least one of the one or more connector bodies and at least one of the one or more fixation ports.

16. The stackable foundation guide of claim 14, further comprising at least one stabilization arm affixed to at least one of the first portion and/or the second portion of the body portion

17. The stackable foundation guide of claim 16, wherein the at least one stabilization arm is configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth.

18. The stackable foundation guide of claim 16, wherein at least one stabilization arm is affixed to a posterior region of the body portion.

19. The stackable foundation guide of claim 14, wherein the body portion comprises an outer surface and an inner surface, and wherein the passageway extends from the outer surface through the inner surface of the body portion.

20. The stackable foundation guide of claim 14, wherein each of the one or more connector bodies comprise a connection sleeve, the connection sleeve comprising a receiving port extending lengthwise at least partially therethrough.

21. The stackable foundation guide of claim 20, wherein each connection sleeve further comprises a coupling hole, the coupling hole extending widthwise at least partially therethrough, and wherein the coupling hole intersects with the receiving port of the connection sleeve.

22. The stackable foundation guide of claim 14, wherein the one or more fixation ports are configured to receive a fixation mechanism therethrough, and wherein the fixation mechanism is configured for anchoring the foundation guide to a maxillary or mandibular bone of a patient.

23. The stackable foundation guide of claim 22, wherein the fixation mechanism comprises one or more of a fixation pin and/or a fixation screw.

24. The stackable foundation guide of claim 14, wherein the body portion further comprises protrusions formed on an inner surface of the main body and extending outward therefrom in a generally perpendicular direction.

25. The stackable foundation guide of claim 24, wherein the protrusions are disposed proximate to one or more of the one or more fixation ports.

26. A method of using a stackable foundation guide, the method comprising:
a. providing a stackable foundation guide, wherein the stackable foundation guide comprises:
i. a body portion having a generally arcuate shape;
ii. one or more connector bodies spaced generally about the body portion;
iii. one or more fixation ports spaced about the body portion, each of the one or more fixation ports forming a passageway therethrough; and
iv. at least one stabilization arm affixed to the body portion, wherein the at least one stabilization arm is configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth; and
b. fixating the stackable foundation guide to a patient's anatomy.

27. The method of claim 26, further comprising performing a planned surgical procedure and removing the stackable foundation guide upon completion of the planned surgical procedure.

28. The method of claim 26, wherein the body portion comprises a first portion and a second portion, and wherein the first portion and the second portion are coupled together at about a center point thereof in a hingeable manner.

29. A method of using a stackable foundation guide, the method comprising:
a. providing a stackable foundation guide, wherein the stackable foundation guide comprises:
i. a body portion having a first portion and a second portion, wherein the first portion and the second portion are coupled together at about a center point thereof in a hingeable manner;
ii. one or more connector bodies spaced generally about the body portion; and
iii. one or more fixation ports spaced about the body portion, each of the one or more fixation ports forming a passageway therethrough; and
b. fixating the stackable foundation guide to a patient's anatomy.

30. The method of claim 29, wherein fixating the stackable foundation guide to the patient's anatomy comprises pivoting the first portion and the second portion of the body portion to a first open position and then once the stackable foundation guide is orientated in the patient's mouth pivoting the first portion and the second portion of the body portion to a second closed position, and then installing one or more fixation mechanisms through the one or more fixation ports into a maxillary or mandibular bone of a patient.

31. The method of claim 29, wherein the stackable foundation guide further comprises at least one stabilization arm affixed to at least one of the first portion and the second portion of the body portion, wherein the at least one stabilization arm is configured such that at least a portion of it extends to a top of, or past, a crestal aspect of a residual ridge of an edentulous patient's mouth or behind, or in back of, one or more tooth structures on the crestal aspect of the residual ridge of a dentate patient's mouth.

32. The method of claim 29, further comprising performing a planned surgical procedure and removing the stackable foundation guide upon completion of the planned surgical procedure.
